(19) United States
(12) Patent Application Publication
(10) Pub. No.: US 2023/0316132 A1
(43) Pub. Date: Oct. 5, 2023

(54) LEARNING DEVICE, LEARNING METHOD, AND LEARNING PROGRAM

(71) Applicant: NEC Corporation, Minato-ku, Tokyo (JP)

(72) Inventor: Riki Eto, Tokyo (JP)

(73) Assignee: NEC Corporation, Minato-ku, Tokyo (JP)

(21) Appl. No.: 18/023,532

(22) PCT Filed: Aug. 31, 2020
(86) PCT No.: PCT/JP2020/032849

§ 371 Date: Feb. 27, 2023

(51) Int. Cl. G06N 20/00

(52) U.S. Cl. CPC G06N 20/00

(57) ABSTRACT

An input means 81 accepts input of an extended objective function, in which each term indicative of a score of each classification result in an objective function of classification analysis is multiplied by a bias parameter as a parameter indicative of a degree of bias of the score of each classification result concerned. An optimization means 82 optimizes a logistic regression weight in the extended objective function. An estimation means 83 estimates the bias parameter by inverse reinforcement learning using the extended objective function of logistic regression to which the optimized weight is set.

### TECHNICAL FIELD

The present invention relates to a learning device, a learning method, and a learning program for performing inverse reinforcement learning.

### BACKGROUND ART

In the field of machine learning, inverse reinforcement learning technology is known. In inverse reinforcement learning, expert decision-making history data are used to learn a weight (parameter) of each feature in an objective function.

In Non-Patent Literature 1, it is described about maximum entropy inverse reinforcement learning as one of inverse reinforcement learning methods. In the method described in Non-Patent Literature 1, only one reward function R(s, a)=θ·f(s, a) is estimated from expert data D={τ₁, τ₂, . . . , τ_{N}} (note that τᵢ=((s₁, a₁), (s₂, a₂), . . . , (s_{N}, a_{N}))). Expert decision-making can be reproduced by using this estimated θ.

### CITATION LIST

### Non Patent Literature

NPL 1: B. D. Ziebart, A. Maas, J. A. Bagnell, and A. K. Dey, “Maximum entropy inverse reinforcement learning,” In AAAI, AAAI′08, 2008.

### SUMMARY OF INVENTION

### Technical Problem

In algorithms used in machine learning including inverse reinforcement learning as described in Non-Patent Document 1, computations are generally carried out to maximize or minimize an objective function at the time of leaning such as likelihood maximization or error function minimization. However, the objective function at the time of learning may not necessarily express an intended action.

For example, a situation to make a binary classification such as between normality and abnormality is assumed. In a situation to learn a classification method based on data collected by a general method, a case where normal data is determined to be normal and a case where abnormal data is determined to be abnormal are generally treated equally. On the other hand, such a situation that it is expected to bias a classification result intentionally to either one result from an expert point of view is considered. However, it is difficult to design an objective function in consideration of how much degree the classification result is biased.

Therefore, it is an exemplary object of the present invention to provide a learning device, a learning method, and a learning program capable of leaning the degree of biasing a classification result.

### Solution to Problem

A learning device according to the present invention includes: an input means which accepts input of an extended objective function, in which each term indicative of a score of each classification result in an objective function of classification analysis is multiplied by a bias parameter as a parameter indicative of a degree of bias of the score of the classification result; an optimization means which optimizes a logistic regression weight in the extended objective function; and an estimation means which estimates the bias parameter by inverse reinforcement learning using the extended objective function of logistic regression to which the optimized weight is set.

A learning method according to the present invention includes: causing a computer to accept input of an extended objective function, in which each term indicative of a score of each classification result in an objective function of classification analysis is multiplied by a bias parameter as a parameter indicative of a degree of bias of the score of the classification result; causing the computer to optimize a logistic regression weight in the extended objective function; and causing the computer to estimate the bias parameter by inverse reinforcement learning using the extended objective function of logistic regression to which the optimized weight is set.

A learning program according to the present invention causes a computer to execute: input processing to accept input of an extended objective function, in which each term indicative of a score of each classification result in an objective function of classification analysis is multiplied by a bias parameter as a parameter indicative of a degree of bias of the score of the classification result; optimization processing to optimize a logistic regression weight in the extended objective function; and estimation processing to estimate the bias parameter by inverse reinforcement learning using the extended objective function of logistic regression to which the optimized weight is set.

### Advantageous Effects of Invention

According to the present invention, the degree of biasing a classification result can be learned.

### BRIEF DESCRIPTION OF DRAWINGS

FIG. 1 It depicts a block diagram illustrating a configuration example of one embodiment of a learning device according to the present invention.

FIG. 2 It depicts a flowchart illustrating an operation example of the learning device.

FIG. 3 It depicts a block diagram illustrating the outline of a learning device according to the present invention.

FIG. 4 It depicts a schematic block diagram illustrating the configuration of a computer according to at least one of exemplary embodiments.

### DESCRIPTION OF EMBODIMENT

First, a situation assumed in the present invention will be described. Usually, when a model to make a classification is built, the model is quantitatively built based on learning data. For example, a cross entropy loss function is known as an objective function used to learn a model to make a binary classification. For example, the cross entropy loss function is expressed by Equation 1 below.

$$[ Math . 1 ]$$

$$𝒥 = - {\sum }_{i = 1}^{N} \{ {y}_{i} log {a}_{i} + ( 1 - {y}_{i} ) log ( 1 - {a}_{i} ) \} \qquad ( Equation 1 )$$

In Equation 1, aᵢ is a prediction model (output of the prediction model) to make the classification, and yᵢ is correct data indicative of a binary classification result such as abnormal or normal. In the example expressed in Equation 1 above, the first term in Σ on the right side is a term indicative of a score rising when abnormality is determined to be abnormal, and the second term in Σ on the right side is a term indicative of a score rising when normality is determined to be normal. As expressed in Equation 1, the “score at which abnormality is determined to be abnormal” and the “score at which normality is determined to be normal” are treated equally in a general method.

On the other hand, such a situation that the classification accuracy of either one of the scores is expected to improve when classifying therebetween (in other words, such a situation that it is expected to intentionally bias the classification result to either one result) is considered. For example, when two values of “abnormal” and “normal” are classified, there is a case where it is expected to give more preferential treatment to either one result than the other result.

For example, when making a diagnosis of infectious diseases, it is common for an expert to want to improve the accuracy of determining abnormal data to be abnormal more than the accuracy of determining normal data to be normal. However, as described above, since the “score at which abnormality is determined to be abnormal” and the “score at which normality is determined to be normal” are treated equally in the general method, it is difficult to bias the determination result intentionally to either one of the classification results.

For example, it is considered that the normal data is excluded to bias the number of learning abnormal and normal data to increase the number of learning data indicative of abnormality to improve the calculation accuracy of the score at which abnormality is determined to be abnormal. However, since biasing of learning data is also intentional, it is difficult to determine, for example, which normal data is removed from the learning data to perform learning. Therefore, it is also difficult to bias the binary classification results based on the number of samples.

Therefore, in an exemplary embodiment, a parameter indicative of the degree of bias of the score of each classification result (hereinafter referred to as a bias parameter) is introduced into an objective function used for optimization. Unlike an existing hyperparameter indicative of the weight of the score of the classification result itself, this bias parameter is a parameter indicative of the degree of giving importance to the classification result.

Further, in the exemplary embodiment, the introduced bias parameter is estimated by inverse reinforcement learning to estimate the degree of giving importance to the classification result from a so-called expert point of view.

The exemplary embodiment of the present invention will be described below with reference to the drawings.

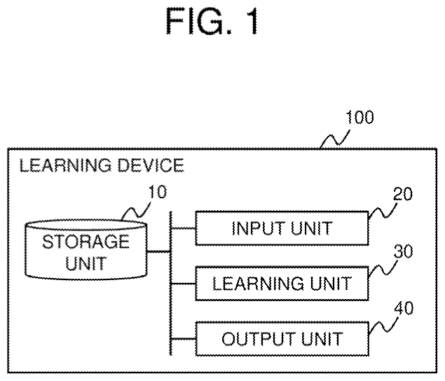

FIG. 1 is a block diagram illustrating a configuration example of one embodiment of a learning device according to the present invention. A learning device 100 of the exemplary embodiment is a device for performing inverse reinforcement learning to estimate a reward (function) from the behavior of a target person. The learning device 100 includes a storage unit 10, an input unit 20, a learning unit 30, and an output unit 40.

The storage unit 10 stores information necessary for the learning device 100 to perform various processing. The storage unit 10 may also store expert decision-making history data (which may also be called trajectories), an objective function, and a prediction model used for learning, which are used by the learning unit 30 for learning to be described later. The modes of the objective function and the prediction model are predetermined.

In the exemplary embodiment, an objective function in which each classification result term is multiplied by a bias parameter based on a cross entropy loss function as an objective function of binary classification analysis. Specifically, in a case of bias parameters λ₁ and λ₂, an objective function into which the bias parameters are introduced (hereinafter, which may also be referred to as an extended objective function) is expressed in Equation 2 below. Equation 2 below expresses an extended objective function in which the first term and the second term are multiplied by the bias parameters λ₁ and λ₂, respectively, where the first term is to calculate a score based on a first classification result and the second term is to calculate a score based on a second classification result in an objective function of binary classification analysis.

$$[ Math . 2 ]$$

$$𝒥 ( {λ}_{1} , {λ}_{2} ) = - {\sum }_{i = 1}^{N} \{ {λ}_{1} {y}_{i} log {a}_{i} + {λ}_{2} ( 1 - {y}_{i} ) log ( 1 - {a}_{i} ) \} \qquad ( Equation 2 )$$

Further, in the exemplary embodiment, logistic regression is exemplified as a prediction model. The logistic regression is expressed in Equation 3 below. In Equation 3, xᵢ is a feature vector and w is a weight for each feature.

$$[ Math . 3 ]$$

$${a}_{i} := \frac{1}{1 + exp ( - {w}^{⊤} {x}_{i} )} = \frac{exp ( {w}^{⊤} {x}_{i} )}{1 + exp ( {w}^{⊤} {x}_{i} )} \qquad ( Equation 3 )$$

For example, there is a prospective customer determination as an example of a binary classification problem. This is a problem to determine whether or not to purchase a specific product using customer data as input. In this case, it can be said to be preferable to carefully determine a customer who has a possibility to purchase the specific product even if only slightly. In this case, in decision-making history data used in inverse reinforcement learning, data including features, such as the address and gender, whether or not the customer purchased the specific product in the past, the annual income, the presence or absence of family, the marital status, the presence or absence of viewing a specific commercial, and the presence or absence of an Internet environment, are used.

However, the mode of the objective function (that is, the extended objective function) into which the bias parameters are introduced is not limited to the function based on the cross entropy loss function as expressed in Equation 2 above, and the mode of the prediction model is also not limited to logistic regression expressed in Equation 3 above. In other words, the mode of the function is optional as long as it is an objective function including bias parameters that give weights to respective scores calculated according to deviations from respective prediction results (classification results) by the prediction model. Specifically, as the extended objective function, an extended objective function, in which each term indicative of the score of each classification result in the objective function (here, the cross entropy loss function) of classification analysis is multiplied by a parameter (bias parameter) indicative of the degree of bias of the score of each classification result, is used.

Further, the storage unit 10 may store a mathematical optimization solver to realize the learning unit 30 to be described later. Note that the content of the mathematical optimization solver is optional, which should be determined according to the environment and device to run the mathematical optimization solver. For example, the storage unit 10 is realized by a magnetic disk and the like.

The input unit 20 accepts input of information necessary for the learning device 100 to perform various processing. For example, the input unit 20 may accept input of the decision-making history data described above. Further, the input unit 20 accepts input of an objective function used by the learning unit 30 to perform learning to be described later. Note that the content of the objective function will be described later. The input unit 20 may also accept input of the objective function by reading the objective function stored in the storage unit 10.

The learning unit 30 performs inverse reinforcement learning based on the input decision-making history data to estimate the objective function (reward function). Specifically, as an order problem of inverse reinforcement learning, the learning unit 30 of the exemplary embodiment sets a logistic regression problem with the objective function as an extended objective function to estimate each bias parameter as an inverse problem.

First, when the input unit 20 accepts the extended objective function, the learning unit 30 generates an objective function with a value set for each bias parameter. In the initial state, the learning unit 30 just has to set a bias parameter λᵢ of any value (for example, λᵢ=1) to the objective function. Here, it is assumed that the learning unit 30 uses, as the extended objective function, an extended objective function, in which each term indicative of the score of each classification result in the cross entropy loss function is multiplied by each bias parameter.

Next, the learning unit 30 learns the prediction model by fixing each bias parameter. Specifically, the learning unit 30 fixes each bias parameter λ to optimize the set logistic regression problem. For example, the learning unit 30 may update the logistic regression weight w using Equation 4 below (specifically, by a gradient descent method using a partial derivative of the logistic regression weight).

$$[ Math . 4 ]$$

$$\frac{\partial 𝒥 ( {λ}_{1} , {λ}_{2} )}{\partial w} = - {\sum }_{i = 1}^{N} \{ {λ}_{1} {t}_{i} ( 1 - {a}_{i} ) - {λ}_{2} ( 1 - {t}_{i} ) {a}_{i} \} {x}_{i} \qquad ( Equation 4 )$$

Then, the learning unit 30 estimates a decision-making content based on the generated prediction model. Specifically, the learning unit 30 applies the input decision-making history data to the optimized logistic regression to estimate an expert decision-making content.

After that, the learning unit 30 estimates bias parameters to bring the estimated decision-making content close to the decision-making history data in order to update the extended objective function. Note that since a method of bringing the decision-making content close to the decision-making history data is similar to a method used in general inverse reinforcement learning, the detailed description thereof will be omitted.

After that, the learning unit 30 repeats learning of the prediction model and bias parameter updating processing until a predetermined condition is met to generate a final objective function (extended objective function).

The output unit 40 outputs information about the generated objective function. The output unit 40 may output the generated objective function itself, or output bias parameters set according to the prediction results.

The input unit 20, the learning unit 30, and the output unit 40 are implemented by a processor (for example, a CPU (Central Processing Unit) or a GPU (Graphics Processing Unit)) of a computer that operates according to a program (learning program).

For example, the program may be stored in the storage unit 10 included in the learning device 100, and the processor may read the program to work as the input unit 20, the learning unit 30, and the output unit 40 according to the program. Further, the functionality of the learning device 100 may be provided in a SaaS (Software as a Service) form.

Further, the input unit 20, the learning unit 30, and the output unit 40 may be implemented in dedicated hardware, respectively. Further, some or all of components of each device may be realized by a general-purpose or dedicated circuit (circuitry), or realized by the processor or a combination thereof. These components may be configured by a single chip, or configured by two or more chips connected through a bus. Further, some or all of components of each device may be realized by a combination of the circuitry described above and the program.

Further, when some or all of the components of the learning device 100 are realized by two or more information processing devices or circuits, the two or more information processing devices or circuits may be arranged centrally or in a distributed manner. For example, each of the information processing devices or circuits may also be realized as a form connected through a communication network such as a client server system or a cloud computing system.

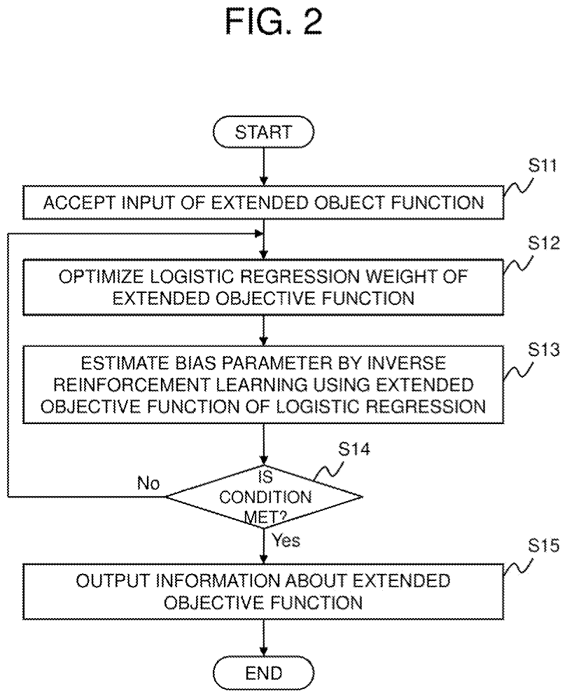

Next, the operation of the learning device 100 of the exemplary embodiment will be described. FIG. 2 is a flowchart illustrating an operation example of the learning device 100 of the exemplary embodiment.

First, the input unit 20 accepts input of an extended objective function (step S11). Next, the learning unit 30 optimizes the logistic regression weight in the extended objective function (step S12), and estimates bias parameters by inverse reinforcement learning using the extended objective function of logistic regression to which the optimized weight is set (step S13). When the predetermined condition is not met (No in step S14), the processes step S12 to step S13 are repeated. On the other hand, when the predetermined condition is met, the output unit 40 outputs information about a final extended objective function (step S15).

As described above, in the exemplary embodiment, the input unit 20 accepts input of the extended objective function, and the learning unit 30 optimizes the logistic regression weight in the extended objective function, and estimates bias parameters by inverse reinforcement learning using the extended objective function of logistic regression to which the optimized weight is set. Thus, the degree of biasing the classification results can be learned.

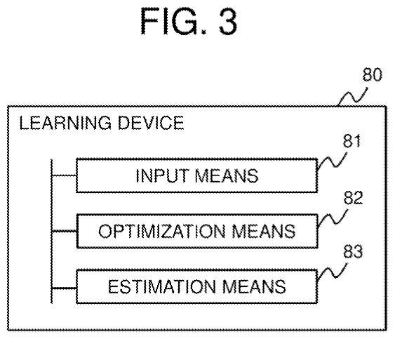

Next, the outline of the present invention will be described. FIG. 3 is a block diagram illustrating the outline of a learning device according to the present invention. A learning device 80 (for example, the learning device 100) according to the present invention includes an input means 81 (for example, the input unit 20) which accepts input of an extended objective function (for example, the objective function expressed in Equation 2 above), in which each term indicative of the score of each classification result in an objective function (for example, the cross entropy loss function) of classification analysis (for example, binary classification analysis) is multiplied by a bias parameter (for example, λ₁, λ₂) as each parameter indicative of the degree of bias of the score of each classification result, an optimization means 82 (for example, the learning unit 30) which optimizes the weight (for example, w^{T} in Equation 3 above) of logistic regression (for example, Equation 3 above) in the extended objective function, and an estimation means 83 (for example, the learning unit 30) which estimates bias parameters by inverse reinforcement learning using the extended objective function of logistic regression to which the optimized weight is set.

According to such a configuration, the degree of biasing the classification results can be learned.

Further, the input means 81 may accept input of an extended objective function, in which a term to calculate a score based on the first classification result (for example, the first term in Equation 2) and a term to calculate a score based on the second classification result (for example, the second term in Equation 2) in the objective function of binary classification analysis as the extended objective function are multiplied by bias parameters, respectively.

Specifically, the input means 81 may accept input of an extended objective function (for example, Equation 3 above), in which each term indicative of the score of each classification result in the cross entropy loss function as the extended objective function is multiplied by each bias parameter.

Further, the optimization means 82 may update the logistic regression weight in the extended objective function by the gradient descent method using a partial derivative of the logistic regression weight (for example, using Equation 4 above) to optimize the logistic regression weight.

Further, the estimation means 83 may estimate the decision-making content from the decision-making history data to estimate bias parameters by inverse reinforcement learning to bring the estimated decision-making content close to the decision-making history data.

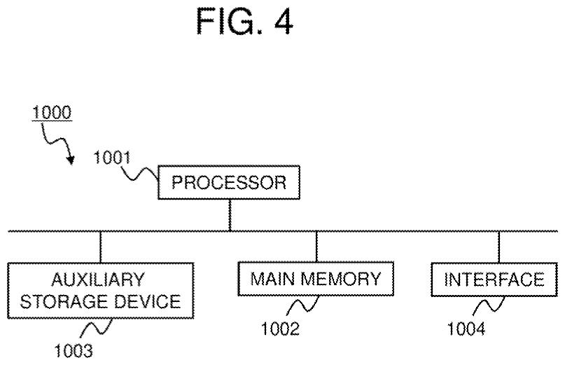

FIG. 4 is a schematic block diagram illustrating the configuration of a computer according to at least one of the exemplary embodiments. A computer 1000 includes a processor 1001, a main storage device 1002, an auxiliary storage device 1003, and an interface 1004.

The learning device 80 described above is mounted in the computer 1000. Then, the operation of each processing unit described above is stored in the auxiliary storage device 1003 in the form of a program (learning program). The processor 1001 reads the program from the auxiliary storage device 1003, expands the program in the main storage device 1002, and executes the above processing according to the program.

Note that, in at least one of the exemplary embodiments, the auxiliary storage device 1003 is an example of a non-transitory tangible medium. As examples of non-transitory tangible media, there are a magnetic disk, a magneto-optical disk, a CD-ROM (Compact Disc Read-only memory), a DVD-ROM (Read-only memory), and a semiconductor memory connected through the interface 1004. Further, when this program is delivered to the computer 1000 by a communication line, the computer 1000 that received the delivery may expand the program in the main storage device 1002 and execute the above processing.

Further, the program may be to implement some of the functions described above. Further, the program may be a so-called differential file (differential program) that implements the functions described above in combination with another program already stored in the auxiliary storage device 1003.

Part or all of the aforementioned exemplary embodiment can also be described in supplementary notes below, but the present invention is not limited to the supplementary notes below.

(Supplementary Note 1)

A learning device including: an input means which accepts input of an extended objective function, in which each term indicative of a score of each classification result in an objective function of classification analysis is multiplied by a bias parameter as a parameter indicative of a degree of bias of the score of each classification result concerned; an optimization means which optimizes a logistic regression weight in the extended objective function; and an estimation means which estimates the bias parameter by inverse reinforcement learning using the extended objective function of logistic regression to which the optimized weight is set.

(Supplementary Note 2)

The learning device according to Supplementary Note 1, wherein the input means accepts input of an extended objective function, in which a term to calculate a score based on a first classification result and a term to calculate a score based on a second classification result in an objective function of binary classification analysis as the extended objective function are multiplied by bias parameters, respectively.

(Supplementary Note 3)

The learning device according to Supplementary Note 1 or Supplementary Note 2, wherein the input means accepts input of an extended objective function, in which each term indicative of a score of each classification result in a cross entropy loss function as the extended objective function is multiplied by a bias parameter.

(Supplementary Note 4)

The learning device according to any one of Supplementary Note 1 to Supplementary Note 3, wherein the optimization means updates the logistic regression weight in the extended objective function by a gradient descent method using a partial derivative of the logistic regression weight to optimize the logistic regression weight.

(Supplementary Note 5)

The learning device according to any one of Supplementary Note 1 to Supplementary Note 4, wherein the estimation means estimates a decision-making content from decision-making history data, and estimates bias parameters by inverse reinforcement learning to bring the estimated decision-making content close to the decision-making history data.

(Supplementary Note 6)

A leaning method including: causing a computer to accept input of an extended objective function, in which each term indicative of a score of each classification result in an objective function of classification analysis is multiplied by a bias parameter as a parameter indicative of a degree of bias of the score of each classification result concerned; causing the computer to optimize a logistic regression weight in the extended objective function; and causing the computer to estimate the bias parameter by inverse reinforcement learning using the extended objective function of logistic regression to which the optimized weight is set.

(Supplementary Note 7)

The learning method according to Supplementary Note 6, wherein the computer accepts input of an extended objective function, in which a term to calculate a score based on a first classification result and a term to calculate a score based on a second classification result in an objective function of binary classification analysis as the extended objective function are multiplied by bias parameters, respectively.

(Supplementary Note 8)

A program storage medium which stores a learning program for causing a computer to execute: input processing to accept input of an extended objective function, in which each term indicative of a score of each classification result in an objective function of classification analysis is multiplied by a bias parameter as a parameter indicative of a degree of bias of the score of each classification result concerned; optimization processing to optimize a logistic regression weight in the extended objective function; and estimation processing to estimate the bias parameter by inverse reinforcement learning using the extended objective function of logistic regression to which the optimized weight is set.

(Supplementary Note 9)

The program storage medium according to Supplementary Note 8, which stores the learning program for further causing the computer in the input processing to accept input of an extended objective function, in which a term to calculate a score based on a first classification result and a term to calculate a score based on a second classification result in an objective function of binary classification analysis as the extended objective function are multiplied by bias parameters, respectively.

(Supplementary Note 10)

A learning program causing a computer to execute: input processing to accept input of an extended objective function, in which each term indicative of a score of each classification result in an objective function of classification analysis is multiplied by a bias parameter as a parameter indicative of a degree of bias of the score of each classification result concerned; optimization processing to optimize a logistic regression weight in the extended objective function; and estimation processing to estimate the bias parameter by inverse reinforcement learning using the extended objective function of logistic regression to which the optimized weight is set.

(Supplementary Note 11)

The learning program according to Supplementary Note 10, further causing the computer in the input processing to accept input of an extended objective function, in which a term to calculate a score based on a first classification result and a term to calculate a score based on a second classification result in an objective function of binary classification analysis as the extended objective function are multiplied by bias parameters, respectively.

While the invention as claimed in this application has been described above with reference to the exemplary embodiment, the invention is not limited to the above-mentioned exemplary embodiment. Various changes understandable to persons skilled in the art can be made in the configuration and details of the invention within the scope of the invention as claimed in this application.

### REFERENCE SIGNS LIST

10 storage unit
20 input unit
30 learning unit
40 output unit
100 learning device

What is claimed is:

1. A learning device comprising:
a memory storing instructions; and
one or more processors configured to execute the instructions to:
accept input of an extended objective function, in which each term indicative of a score of each classification result in an objective function of classification analysis is multiplied by a bias parameter as a parameter indicative of a degree of bias of the score of each classification result concerned;
optimize a logistic regression weight in the extended objective function; and
estimate the bias parameter by inverse reinforcement learning using the extended objective function of logistic regression to which the optimized weight is set.

2. The learning device according to claim 1, wherein the processor is configured to execute the instructions to accept input of an extended objective function, in which a term to calculate a score based on a first classification result and a term to calculate a score based on a second classification result in an objective function of binary classification analysis as the extended objective function are multiplied by bias parameters, respectively.

3. The learning device according to claim 1, wherein the processor is configured to execute the instructions to accept input of an extended objective function, in which each term indicative of a score of each classification result in a cross entropy loss function as the extended objective function is multiplied by a bias parameter.

4. The learning device according to claim 1, wherein the processor is configured to execute the instructions to update the logistic regression weight in the extended objective function by a gradient descent method using a partial derivative of the logistic regression weight to optimize the logistic regression weight.

5. The learning device according to claim 1, wherein the processor is configured to execute the instructions to estimate a decision-making content from decision-making history data, and estimate bias parameters by inverse reinforcement learning to bring the estimated decision-making content close to the decision-making history data.

6. A learning method comprising:
causing a computer to accept input of an extended objective function, in which each term indicative of a score of each classification result in an objective function of classification analysis is multiplied by a bias parameter as a parameter indicative of a degree of bias of the score of each classification result concerned;
causing the computer to optimize a logistic regression weight in the extended objective function; and
causing the computer to estimate the bias parameter by inverse reinforcement learning using the extended objective function of logistic regression to which the optimized weight is set.

7. The learning method according to claim 6, wherein the computer accepts input of an extended objective function, in which a term to calculate a score based on a first classification result and a term to calculate a score based on a second classification result in an objective function of binary classification analysis as the extended objective function are multiplied by bias parameters, respectively.

8. A non-transitory computer readable information recording medium storing a learning program for causing a computer to execute:
input processing to accept input of an extended objective function, in which each term indicative of a score of each classification result in an objective function of classification analysis is multiplied by a bias parameter as a parameter indicative of a degree of bias of the score of each classification result concerned;
optimization processing to optimize a logistic regression weight in the extended objective function; and
estimation processing to estimate the bias parameter by inverse reinforcement learning using the extended objective function of logistic regression to which the optimized weight is set.

9. The non-transitory computer readable information recording medium according to claim 8, which stores a learning program for further causing the computer in the input processing to accept input of an extended objective function, in which a term to calculate a score based on a first classification result and a term to calculate a score based on a second classification result in an objective function of binary classification analysis as the extended objective function are multiplied by bias parameters, respectively.
